(19) United States
(12) Patent Application Publication
(10) Pub. No.: US 2006/0147883 A1
(43) Pub. Date: Jul. 6, 2006

(54) Method for teaching typing

(76) Inventor: Rita Herman, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/318,962

(22) Filed: Dec. 27, 2005

Related U.S. Application Data
(60) Provisional application No. 60/641,402, filed on Jan. 5, 2005.

(51) Int. Cl. G09B 13/00

(52) U.S. Cl. 434/227

(57) ABSTRACT

The present invention is directed to a method of teaching typing wherein the student associates the keys on the keyboard with a person, place, thing or emotion and is able to more readily learn the position of each key. Further, the method of the present invention provides immediate gratification to the student as they are able to instantly visually appreciate the accuracy of their typing on a computer monitor that is attached to the keyboard.

### CROSS-REFERENCE TO RELATED APPLICATION

This application claims the benefit of U.S. Provisional Patent Application No. 60/641,402 filed Jan. 5, 2005, entitled “Method for Teaching Typing” which is hereby incorporated by reference in its entirety.

### BACKGROUND OF THE INVENTION

1. Field of the Invention

The present invention relates to a visual method for teaching typing.

2. Description of Related Art

The most widely accepted method for efficient keyboard input is the touch typing procedure. In this procedure, the typist places the fingers on the correct home keys across the width of the keyboard, which read “ASDFJKL;” from left to right. The thumbs are placed over the space bar. Each finger rests lightly on its home key and does not move unless it reaches to strike keys immediately above or below the home key, or, in the case of each of the index fingers, the additional two keys immediately to the sides of the home keys. Tthe finger quickly returns to its home key. Thus, each finger has only certain keys that it should strike.

Heretofore, keyboarding has been a skill taught at the high school level. Many suitable teaching systems exist for students of that level. However, the explosive growth in the use of computers has reached as far down as elementary school and students as young as kindergarteners, if not younger, are now using a computer keyboard to work various computer programs. Even if a program requires the striking of only one or two keys on the keyboard, the students are striking keys with the wrong fingers and using other incorrect keyboarding techniques. Typing teachers agree that students who form incorrect keyboarding techniques are extremely difficult to retrain. It is much more difficult to teach a student who has ingrained, incorrect habits of keyboarding than to teach a student who has never used the keyboard. Breaking incorrect habits is frustrating and next to impossible in many cases.

Young students and/or students with learning disabilities can find it difficult to learn the keys on the keyboard. The keys are not in alphabetical order and even locating a key many times is difficult. Further, many students attempt to strike keys with the incorrect finger. The keyboard is an overwhelming mystery to these students. Moreover, the poor habits that they learn at this age will significantly hamper their ability to learn correct typing procedure. Further, many students of typing find it frustrating that they do not see the results of their typing efforts until after they have completed a lesson or a typing drill. This is because it has been widely thought that one should not look at what they are typing when they are learning how to type. Instead, teachers have instructed students of typing that they should be looking away from what they are typing and at the paper copy from which they are learning to type.

What is needed and has not heretofore been developed is a method of teaching typing that creates an association with the keys on a keyboard and enables the students to have their thoughts automatically presented to a screen in front of them.

### SUMMARY OF THE INVENTION

The present invention is directed to a method of teaching typing wherein the student associates the keys on the keyboard with a person, place, thing or emotion and is able to more readily learn the position of each key. Further, the method of the present invention provides immediate gratification to the student as they are able to instantly visually appreciate the accuracy of their typing on a computer monitor that is attached to the keyboard. The method for teaching a student to type on a computer has the steps of:

a) providing a computer terminal;

b) providing a keyboard coupled to the terminal;

c) providing a word processing program;

d) correlating keys of the keyboard with stories; and

e) typing keys on the keyboard and having letters that correlate to the typed keys displayed on the terminal for immediate viewing by a student. The letters displayed on the terminal may be of a sufficient size to be easily read by the student. Further, the letters displayed on the terminal may be of different font styles. The stories told to the student enable the student to associate the relative location of the keys on the keyboard. At least one of the keys on the keyboard may be texturized. Further, the keys of the keyboard may represent a fictional town. In the method of the present invention and as stated above, the typed keys displayed on the terminal provide an instant gratification for the student.

The present invention also provides a method for teaching a student to type on a computer having the steps of:

a) telling a student at least one story that correlates individual keys of a keyboard with at least one of a person, place, thing, emotion or expression;

b) providing a computer terminal;

c) providing a keyboard coupled to the terminal;

d) providing a word processing program;

e) having the student place at least one hand on the keyboard; and

f) retelling at least one story as the student presses individual keys that correlate to the story while viewing the computer terminal. The letters that correlate to the pressed keys are displayed on the terminal for immediate viewing by the student. Further, the stories enable the student to associate the relative location of the keys on the keyboard.

### BRIEF DESCRIPTION OF THE DRAWINGS

FIG. 1 is a top plan view of a chart that correlates the keys of a keyboard to a story;

FIG. 2 is a top plan view of a chart showing the keys of a QWERTY keyboard; and

FIG. 3 is a side perspective view of a child typing at a keyboard and viewing the monitor.

### DETAILED DESCRIPTION OF THE INVENTION

For purposes of the description hereinafter, the terms “top”, “bottom”, “left”, right”, “above”, “below” and derivatives thereof, shall relate to the invention as it is oriented in the drawing figures. However, it is to be understood that the invention may assume various alternative variations, except where expressly specified to the contrary. Further, many desirable features of the invention will be apparent to those of ordinary skill in the art upon reading the description of the invention, taken with the accompanying figures.

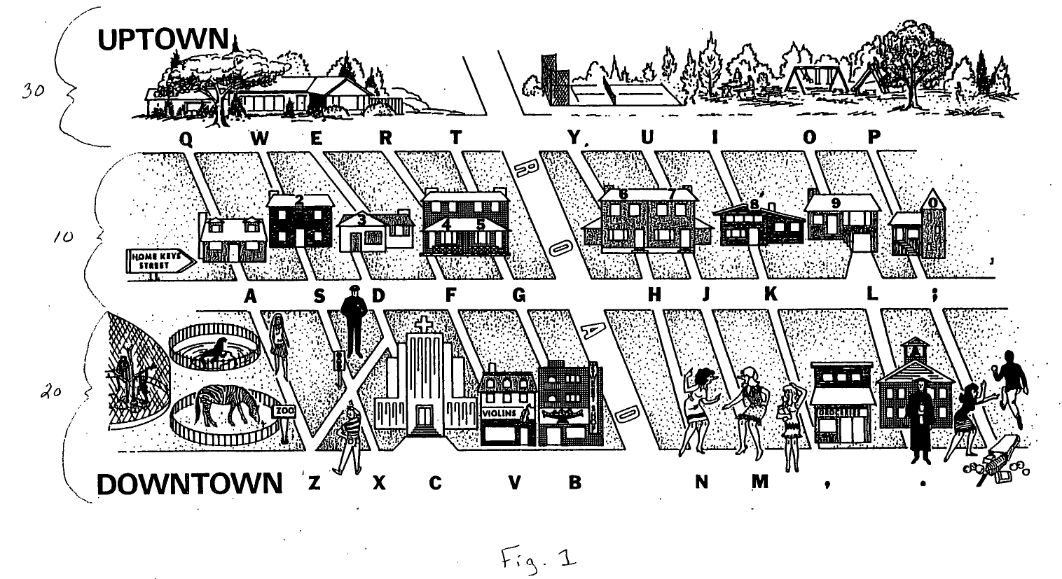

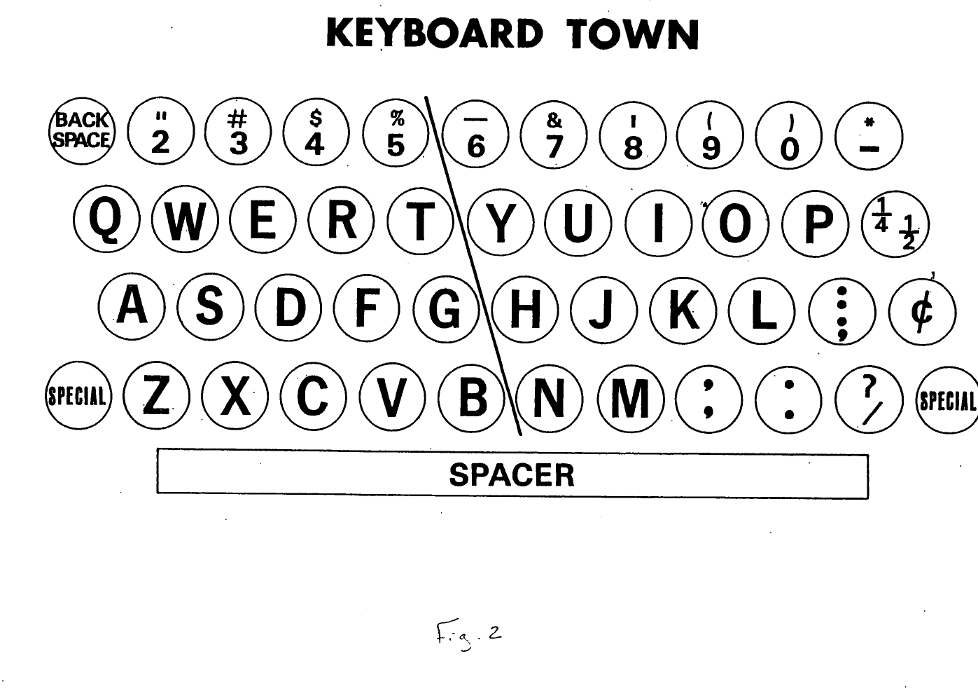

The present invention is a method of teaching typing wherein the student associates the keys on the keyboard with a person, place, thing or emotion and is able to more readily learn the position of each key. Further, the method of the present invention provides immediate gratification to the student as they are able to instantly visually appreciate the accuracy of their typing on a computer monitor that is attached to the keyboard. The method teaches a student the proper fingering of keys on a keyboard so that communication skills can be automatic going from thought to screen and without looking at the keyboard while typing. Through the use of this method, interpersonal relationships are emphasized and human traits can be identified. FIG. 1 illustrates a chart that correlates the keys of a keyboard to a story. FIG. 2 illustrates a chart showing the keys of a QWERTY keyboard.

In one embodiment of the present invention and as shown in FIG. 1, the method divides the main keys of a standard QWERTY keyboard into three rows. The middle row 10 is the home street. The middle row 10 is where the keys on the keyboard represent people. For instance, the “A” key stands for Alice, the “S” key for Sam, the “D” key stands for Deborah, the “F” key for Frank, and the “G” key for George. The bottom row 20 is where the keys on the keyboard represent people, places or things in downtown. For instance, the “Z” key represents the Zoo and/or Zebras, the “X” key represents Crossroads in life, the “C” key represents the sound clue “Cee” (pronounced as see), the “V” key represents a Violin store, the “B” key represents a Bakery. The top row 30 is where the keys on the keyboard represent people, places, things or emotions/expressions. For instance, the “Q” key represents a wizard named Q-Wert that asks a lot of Questions, the “W” key represents questions like Who?, What?, When?, Where? and Why?. The “E” key represents emotions like Elation. The “R” key represents the sound clue “are”. The “T” key represents emotions or expressions like Tough or Trying.

In a first step of this embodiment, the teacher uses puppets, props and stories to quickly familiarize the student with keys of the middle row 10, the bottom row 20 and the top row 30. For example, the teacher could tell a story about Alice, who lives at the “A” key in the middle row 10, and how she went down one row to the downtown bottom row 20 to the Zoo to feed the Zebras, who are located at the “Z” key. Next, Alice went uptown two rows to the top row 30 to see a magician named Q-Wert located at the “Q” key who asked her lots of Questions about her visit to the Zoo. The teacher can also tell a story about Sam, who lives at the “S” key in the middle row 10, and how he went down one row to the downtown bottom row 20 to the “X” key because he is at a crossroad in his life. He went up two rows to the “W” key to ask himself questions like “What am I going to do for a career?” and “Where am I going to go to college?”. The students will begin to learn the location of the individual keys through stories of this type. In a next step, the teacher will tell the stories with the student having their fingers properly positioned on a keyboard that is coupled to a computer terminal that has a word processing program such as Microsoft® Word®. As the story is told, the students are instructed to move their fingers and press on the keys along with the progression of the character in the story. The movement of the appropriate fingers on each hand is via the standard positions of the fingers to strike the related keys that are presently utilized in the teaching of typing. For example, the left pinky finger rests on the “A” key and is used to press the “Q”, “A” and “Z” keys, the right pinky finger rests on the semi-colon key and is used to press the “P”, “;” and “/” keys, etc. This is known as the finger by finger method of typing. So, for example, when Alice is introduced, the student will press the “A” key with their left pinky finger. When Alice goes to the Zoo, the student will move down one row with the same finger and press the “Z” key. When Alice visits Q-Wert, the student will move up two rows with the same finger and press the “Q” key. The student can see the letters they have typed on the monitor of the computer terminal. Alternatively, the present invention could be taught through a television screen coupled up to a keyboard and a microprocessor coupled to the television and keyboard, wherein the microprocessor enables the letters for the corresponding pressed keys to be shown on the screen. The student is actually typing and learning the position and relative location of the keys of a keyboard through the use of stories, such as the Alice story, and immediately seeing what he/she has learned on the screen. Once the student has heard stories about all of the main keys on the keyboard and has undergone typing exercises, such as the one described above, he/she is able to type efficiently and without having to look down at the keyboard because he/she has learned the location of the keys. Thus, through the association of stories, the student will remember which fingers go with which keys and the relative location of each key. Within a very short period of time, the students can begin keyboarding and expressing their thoughts and opinions and instantly see the expression on the computer monitor.

In one embodiment of the present invention, the letters keyed in by the student are shown on the monitor in differing font sizes, interesting font styles and varied backgrounds to provide more visual stimuli to the student learning to type. For example, when a student is learning the location of the “A”, “Z” and “Q” keys via the story about Alice going to the Zoo, the background that the letters appear on may be striped like a Zebra and the font size may be large, for example, 24 point font instead of a 12 point font. Further, a small font size, such as 6 point font instead of a 12 point font may be desired. A small font size could indicate quietness or shyness of the person typing the story or relaying thoughts and expressions. When the student is learning the location of the “S”, “X” and “W” keys via the story about Sam at the crossroads of his life, the background that the letters appear on may have faint question marks on it and the font style may be bold, like Rockwell Extra Bold style or italicized or underlined to strengthen the association with the student that this is a difficult decision for Sam. It has been found that the large font assists in the student focusing on the skill of typing on a computer keyboard coupled to a computer screen. Further, it helps the student to focus on the screen, not the keyboard. This method results in a higher level of visual expression, as opposed to written expression where the student concentrates on the keys located on the keyboard.

Additionally, the method of the present invention teaches cognitive recognition to the student. For example, the teacher will provide a concrete concept in a first step, such as instructing the student to type Alice and then type Sam. Then the student will be asked to say what they typed, which would be the word “AS”. Next, the student is provided a semi-concrete concept and instructed to type the letter “A” followed by the letter “S”. Again, the word “AS” will show up on the screen. Finally, the student is provided an abstract concept and instructed to type the word “AS”. Again, the word “AS” will show up on the screen. With the aid of various permutations on the “AS” exercise, the student is able to gain cognitive recognition skills.

Further, in another embodiment of the present invention, one or more keys on the keyboard may be provided with texture. For example, the “Z” key may have fur applied to it, so that the student, without looking, will feel the fur underneath their pinky, associate the key with furry animals at the zoo, and feel confident that they are on the “Z” key. Different tactile feelings for one or more of the keys, such as rough, smooth, furry, etc., will assist the student in memorizing the location of the keys.

It is important to note that the goal of the present invention is to have the student learn to type while focusing on the screen, so that he/she does not realize that their fingers are typing. Therefore, the stories and tactile feel of the keys while the student is looking at the screen facilitates that goal. In some instances, the keyboard can be placed on the lap of the student as opposed to a table or desktop to accomplish this goal. Further, the present invention can be used to teach values to the student through the stories told to correlate the stories or words with the computer keyboard keys. It has been found that the present invention enables students to quickly learn to type and improve their expression through written works.

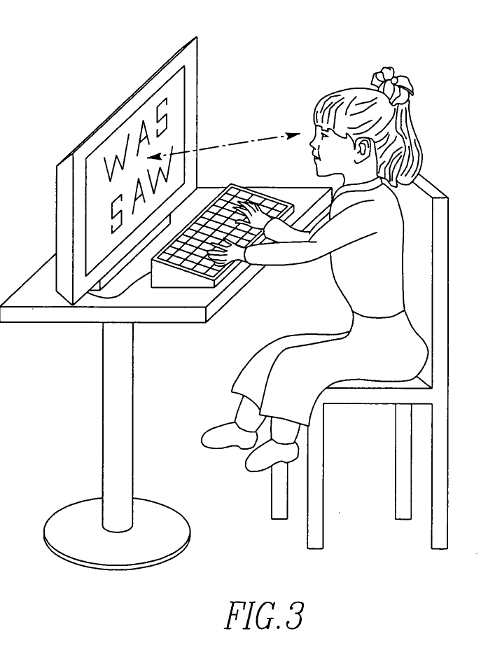

Further, and as shown in FIG. 3, the present method is very liberating to students because they can see the results of what they have learned even before they have mastered the entire keyboard. For example, once the student has undergone the exercise described above with respect to Alice and Sam, they will know the position and relative location of keys “Q”, “A”, “Z”, “W”, “S, and “X”. Thus, they will already be able to type real words and see them on the monitor, such as “SAW”, “WAS”, “SAX” and “AX”. This provides the students with an ongoing sense of accomplishment and prompts them to want to learn more key locations. Further, the student has immediate gratification because they can see what they are typing on the screen instantly. As they learn more keys through the method of the present invention, they can begin expanding their horizons and expressing their thoughts and opinions via typing. Additionally, the student does not have to worry about making a permanent mistake or typing the wrong thing because any errors can be instantly deleted with the delete key or backspace bar on the keyboard. Using the keyboard overcomes the fear and nervousness of making mistakes because deleting the mistakes removes them forever and no one has to be aware of them. The interaction between the keyboard, monitor and the message on the screen is immediate and very direct, so the student can concentrate on the creative process which pencil and paper can sometimes inhibit.

Additionally, the method of the present invention can be tailored to various learning approaches. In general, students learn three different ways: through listening (auditory), seeing (visual) or touch (kinesthetic) means. The method of the present invention can utilize any or all of them. For example, puppets provide the visual stimulus, stories or music can provide the auditory stimulus, and materials placed on the keys of a keyboard can provide the kinesthetic stimulus. Also, the method of the present invention can be used to teach a wide range of topics because the stories can be tailored to virtually any type of lesson. For example, the story of Alice going downtown to the Zoo to the see the Zebra can be delved into further to discuss visual perception, e.g. “Is the Zebra black with white stripes or white with black stripes?” and moral values, e.g. “The color of the Zebra doesn't tell you anything about the Zebra, just like the color of a person's skin does not tell you anything about the person”. Further, reading, writing, poetry, art and interpersonal relationships can be taught through the method of the present invention.

The method of the present invention can also be used to teach adults, as well as non-English speaking children and adults, keyboarding, reading and other skills.

The method of the present invention has been tested on a variety of students with overwhelming success. Many students have been able to begin typing and expressing themselves on the screen in a time frame from a few minutes up to an hour. The disclosed method has been shown to increase learning speed and improve learning comprehension for virtually all children, from average learners to gifted children. Also, the method of the present invention has been tested and proven to work and help children with Asperger Syndrome and attention-span difficulties.

The present invention has been described with reference to the preferred embodiments. Obvious modifications, combinations and alterations will occur to others upon reading the preceding detailed description. It is intended that the invention be construed as including all such modifications, combinations and alterations insofar as they come within the scope of the appended claims or the equivalents thereof.

The invention claimed is:

1. A method for teaching a student to type on a computer, comprising the steps of:
a) providing a computer terminal;
b) providing a keyboard coupled to said terminal;
c) providing a word processing program;
d) correlating keys of the keyboard with stories; and
e) typing keys on the keyboard and having letters that correlate to the typed keys displayed on the terminal for immediate viewing by a student.

2. The method of claim 1, wherein the letters displayed on the terminal are of a sufficient size to be easily read by the student.

3. The method of claim 1, wherein the letters displayed on the terminal are of different font styles.

4. The method of claim 1, wherein the stories enable the student to associate a relative location of the keys on the keyboard.

5. The method of claim 1, wherein at least one of the keys on the keyboard is texturized.

6. The method of claim 1, wherein the keys of the keyboard represent a fictional town.

7. The method of claim 1, wherein the typed keys displayed on the terminal provide an instant gratification for the student.

8. A method for teaching a student to type on a computer, comprising the steps of:
a) telling a student at least one story that correlates individual keys of a keyboard with at least one of a person, place, thing, emotion or expression;
b) providing a computer terminal;
c) providing a keyboard coupled to said terminal;
d) providing a word processing program;
e) having the student place at least one hand on the keyboard; and
f) retelling the at least one story as the student presses individual keys that correlate to the story while viewing the computer terminal.

9. The method of claim 8, wherein letters that correlate to the pressed keys are displayed on the terminal for immediate viewing by the student.

10. The method of claim 9, wherein the letters displayed on the terminal are of a sufficient size to be easily read by the student.

11. The method of claim 9, wherein the letters displayed on the terminal are of different font styles.

12. The method of claim 8, wherein the at least one story enables the student to associate a relative location of the keys on the keyboard and correlate each key with an appropriate finger of the student to activate the respective key.

13. The method of claim 8, wherein at least one of the keys on the keyboard is texturized.

14. The method of claim 8, wherein the keys of the keyboard represent a fictional town.
